(19) United States
(12) Patent Application Publication
(10) Pub. No.: US 2026/0140257 A1
(43) Pub. Date: May 21, 2026

(54) SENSOR ARRANGEMENT COMPRISING AN ULTRASONIC TRANSCEIVER AND AN OPTICAL TRANSCEIVER DEVICE

(71) Applicant: VALEO SCHALTER UND SENSOREN GMBH, Bietigheim-Bissingen (DE)

(72) Inventors: Philipp Maurer, Bietigheim-Bissingen (DE); Violen Kömme, Bietigheim-Bissingen (DE)

(73) Assignee: VALEO SCHALTER UND SENSOREN GMBH, Bietigheim-Bissingen (DE)

(21) Appl. No.: 19/116,640

(22) PCT Filed: Sep. 21, 2023
(86) PCT No.: PCT/EP2023/076007

§ 371 Date: Mar. 28, 2025

(30) Foreign Application Priority Data
Sep. 28, 2022 (DE) 10 2022 124 886.0

(51) Int. Cl. G01S 15/86; G01S 7/481; G01S 7/521; G01S 15/931; G01S 17/86; G01S 17/931

(52) U.S. Cl. CPC G01S 15/86; G01S 7/4813; G01S 7/521; G01S 15/931; G01S 17/86; G01S 17/931

(57) ABSTRACT

A sensor arrangement having an ultrasonic transceiver and an optical transceiver device and a method for measuring the surroundings of a motor vehicle are disclosed herein. The sensor arrangement for a vehicle includes an ultrasonic transceiver and an optical transceiver device. The ultrasonic transceiver is configured to emit ultrasonic waves and to receive reflected ultrasonic waves. The optical transceiver device is configured to emit light and to receive reflected light.

The present invention relates to a sensor arrangement comprising an ultrasonic transceiver and an optical transceiver device and to a method for measuring the surroundings of a motor vehicle. The present invention furthermore relates to a computer program product.

Vehicles, in particular motor vehicles are equipped with ultrasonic transceivers, which emit ultrasonic transmission signals into the surroundings of the motor vehicle and receive ultrasonic reception signals from the surroundings of the vehicle. A distance to the object in the surroundings of the motor vehicle is determined by means of a signal propagation time between the emission of an ultrasonic transmission signal and the arrival of an ultrasonic echo in the ultrasonic reception signal which is due to a reflection of the ultrasonic transmission signal at an object in the surroundings of a vehicle. The actual position of the reflection point can be determined by trilateration or the like if multiple ultrasonic transceivers are used.

In particular for automated driving, for example, for automated parking or for automated starting, small or narrow obstacles such as posts or horizontal bars also have to be reliably detected and in particular obstacles which are very close to an ultrasonic transceiver also have to be reliably detected. Many conventional ultrasonic transceivers can no longer detect obstacles in principle at close range, for example, at a distance of less than 20 cm from the ultrasonic transceiver. In such ultrasonic transceivers, a membrane is used both to generate ultrasonic transmission signals and to receive ultrasonic reception signals reflected by obstacles. To generate the ultrasonic transmission signals, the membrane is usually excited to oscillate with the aid of a piezoelectric element. After ending the excitation, the membrane continues to oscillate. While the membrane oscillates or continues to oscillate, the ultrasonic transceiver is not sensitive or is only slightly sensitive to reflected ultrasonic reception signals. The closer an obstacle is to the ultrasonic transceiver, the shorter is the time-of-flight from transmitting the ultrasonic transmission signal to receiving the reflected ultrasonic reception signal. If the reflection reaches the ultrasonic transceiver during the oscillation or continued oscillation time of the membrane, the obstacle is not detected.

An ultrasonic sensor having a damping element, which is arranged in a housing for damping the oscillation of the membrane, is known from EP 3012654A1 . The damping element is to reduce the continuing oscillations of the membrane, so that obstacles at close range can be detected better.

A reversing warning system having an ultrasonic sensor is known from DE 102013226499 A1. The reversing warning system comprises an ultrasonic sensor which is configured to detect information with respect to the area behind the vehicle and a capacitance sensor, which is configured to detect information with respect to the area behind the vehicle closer than or equal to a previously defined distance. When the ultrasonic sensor does not detect the obstacle which is positioned on the rear side of the vehicle, the capacitance sensor can be configured to detect the obstacle which is positioned on the rear side of the vehicle.

A sensor arrangement for detecting labels on a carrier material is known from DE 102007046769A1 . The sensor arrangement comprises an optical sensor and an ultrasonic sensor for detecting the labels. Both the optical sensor and the ultrasonic sensor operate according to a transmission measurement, i.e. the transmitter and receiver of the optical sensor, on one hand, and the ultrasonic emitter and the ultrasonic receiver of the ultrasonic sensor, on the other hand, are each arranged on both sides of a detection plane, in which the carrier material having the labels is guided relative to the device.

Against this background, one object of the present invention is to further improve a sensor arrangement having an ultrasonic transceiver and the measurement of the surroundings of a motor vehicle by means of ultrasound at close range.

Accordingly, a sensor arrangement for a vehicle is proposed, comprising: an ultrasonic transceiver, which is configured to emit ultrasonic waves and receive reflected ultrasonic waves, and an optical transceiver device, which is configured to emit light and receive reflected light.

Due to the combination of an ultrasonic transceiver with an optical transceiver device, the close range which is not detected or is not detected well by the ultrasonic transceiver can be detected by an optical transceiver device. The close range of the ultrasonic transceiver can comprise, depending on the ultrasonic transceiver and its operation, for example, a distance of up to 5 cm, up to 10 cm, or up to 15 cm from the ultrasonic transceiver. The optical transceiver device can detect, depending on the optical transceiver device and its operation, for example, a distance of up to 20 cm, up to 15 cm, up to 10 cm, or up to 5 cm.

The optical transceiver device can be operated in this case as a type of optical switch. The optical transceiver device emits light, the emitted light can be reflected from a nearby surface. A part of the reflected light is received by the optical transceiver device. If a set threshold is exceeded, an obstacle is detected. It is possible to set which area the optical transceiver device covers by the selection of the threshold value and assumptions about the reflections, e.g., the reflectivity of surfaces, the formation of objects, or the scattering of the light due to typically occurring obstacles with the light used. With this type of operation, the optical transceiver device or an evaluation device for the optical transceiver device only supplies the information of whether or not an obstacle is present. The information can be further processed and linked, for example, with data from other sensors or maps of the surroundings of the vehicle stored by the vehicle.

In particular for automated starting, an obstacle which is incorrectly detected is less risky than an obstacle which is incorrectly not detected, the proposed sensor arrangement can therefore be used for risk reduction during automated driving.

The sensor arrangement comprising the ultrasonic transceiver and the optical transceiver device can be preassembled as an assembly. The sensor arrangement can comprise a housing, a microprocessor, for example, an ASIC, a memory, and/or an electrical connection.

The sensor arrangement is designed in particular for at least partially unconcealed installation in a trim part, e.g., a bumper, a front apron, or a rear apron, of a vehicle. The sensor arrangement can be arranged in a corresponding recess or passage opening of the trim part. Such a sensor arrangement is partially visible when installed as intended on the vehicle. Via the area of the sensor arrangement visible in the installed state, the ultrasonic transceiver can emit ultrasonic waves and receive reflected ultrasonic waves and an optical transceiver device can emit light and receive reflected light via this visible area, without the ultrasonic waves or the light being interfered with in the propagation. The ultrasonic transceiver and the optical transceiver device can be arranged, at least in some areas, in or on a common housing.

According to one embodiment, the ultrasonic transceiver and the optical transceiver device form a unit, which is in particular preassembled, and/or are connected to one another so they are not detachable nondestructively. In particular, the ultrasonic transceiver and the optical transceiver device are arranged in a (preferably common) housing.

A sensor arrangement, in which the ultrasonic transceiver and the optical transceiver device are connected to one another and thus, for example, a stable assembly for installation results, is useful for the installation on a vehicle.

A vehicle, for example, a motor vehicle, is subject in operation to environmental influences such as vibrations, heat, cold, rain, moisture, sunshine, and travel wind. In the sensor arrangement, the ultrasonic transceiver and the optical transceiver device can be arranged for this purpose on or partially in a (in particular common) housing for protection and can be connected to one another and/or to the housing so they are not detachable nondestructively, e.g., potted, embedded, adhesively bonded, welded in, or welded on. In this way, the sensor arrangement can also be protected from environmental influences.

According to one embodiment, the optical transceiver device comprises a light-emitting diode or a laser, in particular for infrared, visible, or ultraviolet light.

A variety of inexpensive optical transmitters are available for the optical transceiver device. In particular light-emitting diodes and lasers, in particular based on semiconductors, can be used in this case. Light-emitting diodes are less focused and usually lower in power than lasers, but are easy to handle in return. Wavelength ranges can be used which are not visible and/or in which less interfering ambient light is present. In particular in the near infrared range, in particular at wavelengths between 780 nm and 1000 nm, an optical transmitter can be inexpensively implemented using semiconductor components, in particular photodiodes or phototransistors.

According to one embodiment, the optical transceiver device of the sensor arrangement comprises a photodiode or a phototransistor.

Photodiodes or phototransistors are used as optical receivers which can receive light emitted by the optical transmitters which is reflected from objects. Phototransistors are more sensitive than photodiodes, since they act as amplifiers at the same time. Photodiodes are often faster than phototransistors. Photodiodes and phototransistors are inexpensive components which are available based on semiconductors for receiving wavelengths between 780 nm and 1000 nm. If a phototransistor is used, light reflected from a nearby surface can reach the phototransistor and a threshold value for obstacle detection can be set directly using a comparator circuit.

According to one embodiment, the optical transceiver device of the sensor arrangement comprises two infrared light-emitting diodes and two phototransistors or photodiodes.

The optical transceiver device can be designed redundantly using two or more infrared light-emitting diodes and two or more phototransistors or photodiodes, so that a failure of individual optical transmitters or receivers does not result in the failure of the sensor arrangement or reduced functionality of the sensor arrangement. In the case of lesser soiling, which does not cover all optical transmitters or optical receivers, it is still possible to operate the optical transceiver device. Functions such as soiling detection can also be implemented using a plurality of optical transmitters and optical receivers.

According to one embodiment, the sensor arrangement comprises a decoupling ring for decoupling oscillations of the ultrasonic transceiver of the sensor arrangement from an accommodating device.

Ultrasonic transceivers usually convert electrical oscillations with the aid of a piezoelectric element, which excites a membrane, into mechanical oscillations. An ultrasonic transmission signal is generated by the oscillations of the membrane. In order that as much power as possible can be converted into the ultrasonic transmission signal, the mechanical oscillation is not to be transferred to components on which the ultrasonic transceiver is arranged. To minimize this transfer, ultrasonic transceivers or the assembly in which the ultrasonic transceiver is integrated can be arranged on the component or connected to the component via a decoupling ring. Thus, for example, ultrasonic transceivers can be installed with their electronics in a housing and this housing and/or the ultrasonic transceiver is arranged in a bumper using a decoupling ring.

According to one embodiment, the decoupling ring of the sensor arrangement is configured to conduct the transmitted and/or reflected light through to the optical transceiver device.

In many applications, an ultrasonic transceiver is to be integrated into a vehicle, e.g., into a bumper, a front apron, or a rear apron, in an unobtrusive, aesthetically appealing, and aerodynamically matched manner, and a decoupling ring is used for the decoupling from the vehicle, or from the bumper, the front apron, or the rear apron. If this decoupling ring can now be used for the transmitted and/or reflected light of the optical transceiver device, a use of the proposed sensor arrangement without changes or with few changes in the exterior area of the vehicle is possible.

According to one embodiment, the decoupling ring of the sensor arrangement is transparent to the emitted and/or reflected light, in particular is transparent to infrared light.

One possibility for configuring the decoupling ring to conduct through the transmitted and/or reflected light to the optical transceiver device is represented by a material of the coupling ring which is transparent to the emitted and/or reflected light, in particular is transparent to infrared light. If the optical transceiver device uses infrared light, for example, a material can also be used which is not transparent to visible light but is transparent to infrared light.

According to one embodiment, the decoupling ring of the sensor arrangement comprises an optical fiber for conducting the emitted and/or reflected light.

An optical fiber can be used for beamforming of the emitted or reflected light, for example, for better decoupling or focusing of the light and/or for conducting the light through the decoupling ring.

According to one embodiment, a bumper, a front apron, or a rear apron comprises one or more of the sensor arrangements.

According to one embodiment, a vehicle comprises one or more of the sensor arrangements and/or a bumper, a front apron, or a rear apron having one or more of the sensor arrangements.

For use in driver assistance systems, such as parking systems, the sensor arrangement can be attached at the points of a vehicle which are forward or reverse in the direction of travel, so that the sensor arrangement can detect obstacles in this area. The one or more sensor arrangements can therefore be arranged, for example, on the bumper, on the front apron, or on the rear apron of a vehicle, in particular a motor vehicle.

Furthermore, a method for measuring the surroundings of a vehicle, in particular using the described sensor arrangement, is proposed, wherein the method comprises the following steps: a) transmitting and receiving ultrasonic signals; b) transmitting and receiving light signals; c) evaluating the received ultrasonic signals for obstacles in the surroundings of the vehicle; and d) evaluating the received light signals for obstacles in the surroundings of the vehicle.

The surroundings are measured using ultrasound by the transmission and reception of ultrasonic signals and the evaluation of the received ultrasonic signals for obstacles in the surroundings of the vehicle. Distances to obstacles can be determined by time-of-flight determinations and the position of obstacles can be determined by trilateration if there are multiple ultrasonic transceivers, from which ultrasonic signals are transmitted. Since the ultrasonic transceivers are usually not capable of detecting obstacles at close range below a minimum distance, the close range is supplemented using an optical measurement. Light signals are transmitted and received for this purpose. The received light signals are evaluated for reflected light, which can originate from an obstacle located close to the ultrasonic transceiver.

According to one embodiment, the received ultrasonic signals are evaluated for obstacles at a distance of greater than 5, preferably greater than 10 cm from a transmitting ultrasonic transceiver and/or the received light signals are evaluated for obstacles at a distance of at most 20, preferably at most 15 cm from a transmitting optical transceiver device.

Ultrasonic transceivers are often not capable of detecting obstacles at close range. The close range, within which obstacles can no longer be detected, can comprise 5 cm, 10 cm, or 15 cm depending on the design. Obstacles in this close range are to be detected by received light signals, for this purpose, received light signals are evaluated for obstacles at close range at a distance of at most 20 cm, 15 cm, 10 cm, or 5 cm. The position and orientation of obstacles can be determined by trilateration with the aid of multiple ultrasonic transceivers. In the evaluation of the light signals, it is often sufficient solely to establish the presence of an obstacle. This permits cost-effective systems for the transmission and reception of the light signals and the evaluation of the transmitted and received light signals. If the evaluation of the light signals is restricted to the close range, in particular the close range not detected by the ultrasonic transceiver, the evaluation of the light signals can supplement the evaluation of the ultrasonic signals in a simple manner with the information as to whether an obstacle is present at close range, in particular in the close range not detected by the ultrasonic transceiver.

According to one embodiment, a starting release, in particular for an automated starting process, is only granted if no obstacle, in particular within an intended travel distance, results for an intended travel direction from the evaluated ultrasonic signals and from the evaluated light signals.

In particular in automated driving, minimizing risk or also the redundancy of various sensor systems is important. In particular in the case of a stationary vehicle, the surroundings of the vehicle can change quickly, for example, due to pedestrians, and at close range, for example, when a pedestrian steps behind a stationary vehicle. If the ultrasonic transceiver is switched off, for example, because the vehicle is switched off, a change of the surroundings of the vehicle is possible without this being able to be detected using the ultrasonic transceiver. If an obstacle is now already located in the close range of the ultrasonic transceiver when the vehicle is switched on, which obstacle can no longer be detected by the ultrasonic transceiver, the obstacle is no longer detected by the ultrasonic transceiver. If a starting release is only granted if no obstacle results both from the evaluation of the ultrasonic signals and also the light signals, the risk for an undetected obstacle in close range will be reduced.

According to one embodiment, soiling on the sensor arrangement is established using at least two infrared diodes and using at least two phototransistors or photodiodes in a sensor arrangement.

If multiple optical transmitters and receivers are provided, for example, two infrared diodes and two phototransistors, it can thus be concluded, for example, if the first phototransistor does not receive a reflection signal, while the second phototransistor receives a reflection signal above a threshold value, that the light path to the first phototransistor is blocked, for example, by dirt. This applies in particular if the two optical receivers are arranged adjacent to one another, for example, with less than 30 mm spacing. If the optical transmitters, for example, a first infrared diode and a second infrared diode, transmit alternately and the reflected signal which reaches the optical receiver differs more strongly than a threshold value, it can thus be concluded that the light path from the infrared diode which generates a lesser reflected signal, to a reflecting object is blocked, for example, by dirt. This applies in particular if the two optical transmitters are arranged adjacent to one another, for example, with less than 30 mm spacing.

A computer program product is furthermore proposed, comprising commands which, when the program is executed by a computer, prompt this computer to execute the method described above.

A computer program product, e.g., a computer program means, can be provided or supplied, for example, as a storage medium such as a memory card, a USB stick, a CD-ROM, a DVD, or in the form of a downloadable file from a server in a network. This may take place for example in a wireless communication network by transmitting a corresponding file containing the computer program product or the computer program means.

The embodiments and features described for the proposed device apply accordingly for the proposed method and vice versa the embodiments and features described for the proposed method also apply accordingly for the proposed device.

Further possible implementations of the invention also comprise not explicitly mentioned combinations of features or embodiments described above or below with regard to the exemplary embodiments. A person skilled in the art will in this case also add individual aspects as improvements or additions to the respective basic form of the invention.

Further advantageous configurations and aspects of the invention are the subject of the dependent claims and of the exemplary embodiments of the invention that are described below. The invention is explained in more detail below on the basis of preferred embodiments with reference to the accompanying figures.

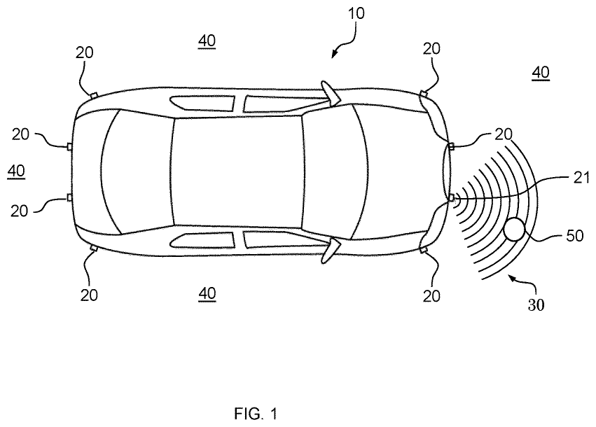

FIG. 1 shows a schematic top view of a motor vehicle having sensor arrangements and an obstacle;

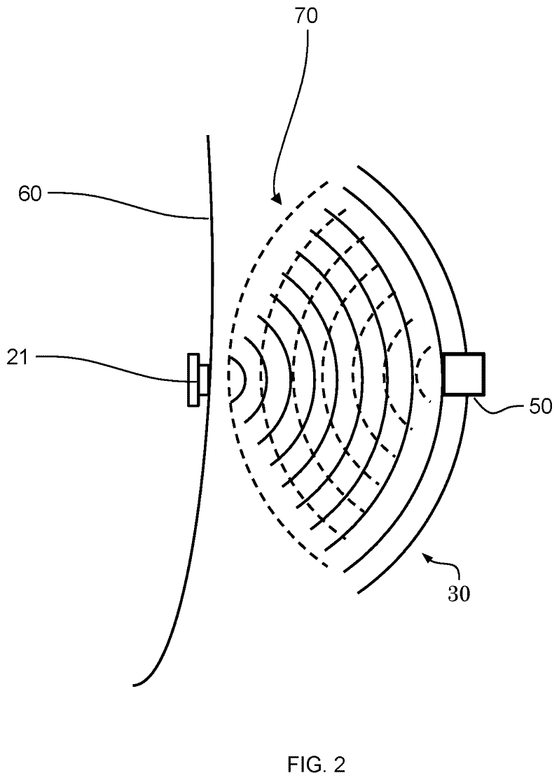

FIG. 2 shows a sensor arrangement and the reflection of ultrasonic waves at an obstacle;

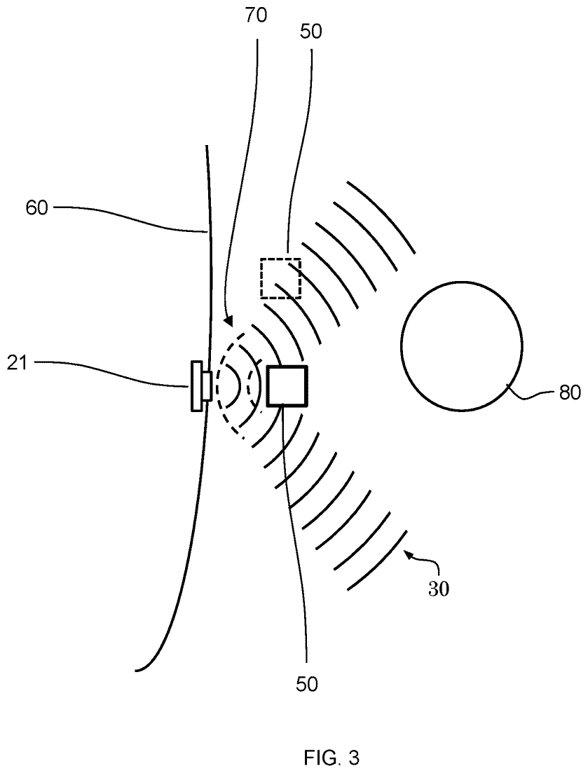

FIG. 3 shows a sensor arrangement and the reflection of ultrasonic waves at a nearby obstacle and the shading of a more distant object;

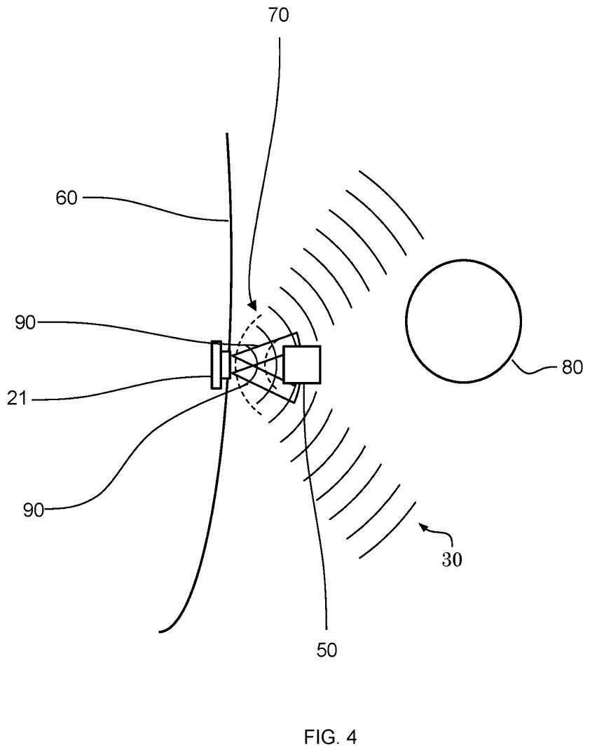

FIG. 4 shows a sensor arrangement and the reflection of ultrasonic waves at a nearby obstacle and the shading of a more distant object and the illumination of the obstacle using light;

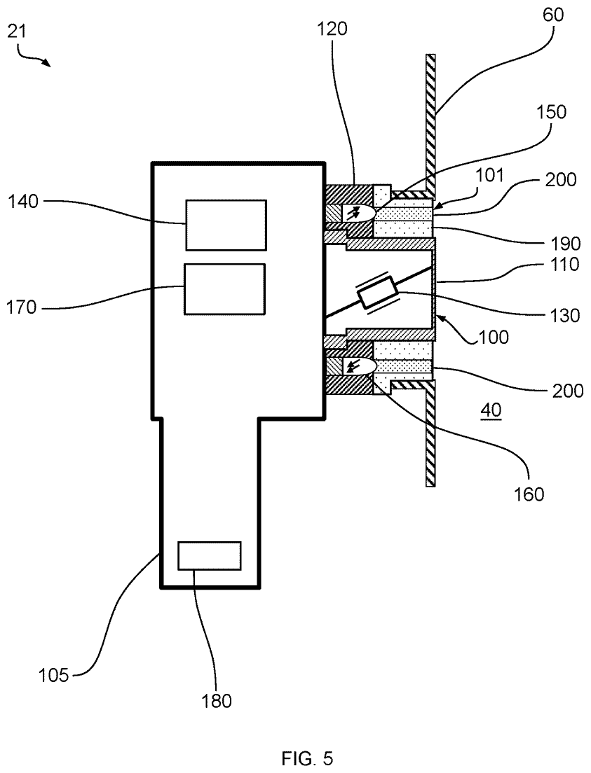

FIG. 5 schematically shows a section through a sensor arrangement having an ultrasonic transceiver and an optical transceiver device in a front apron;

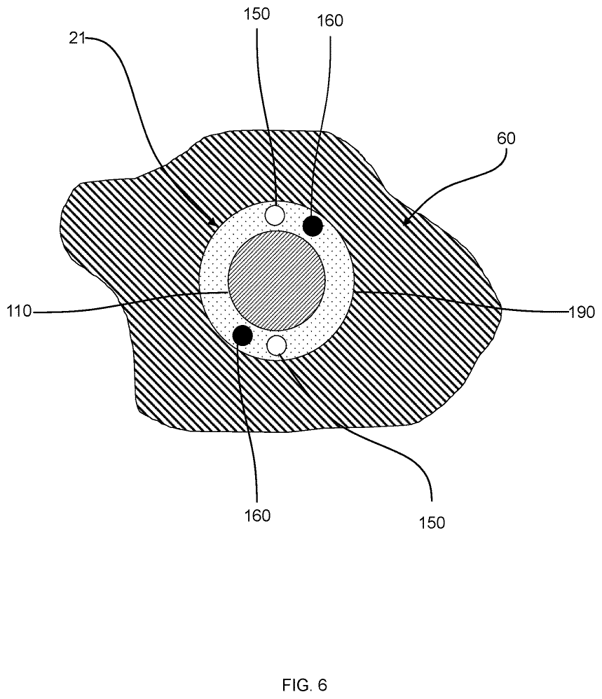

FIG. 6 schematically shows a top view of a sensor arrangement having an ultrasonic transceiver and an optical transceiver device in a front apron; and

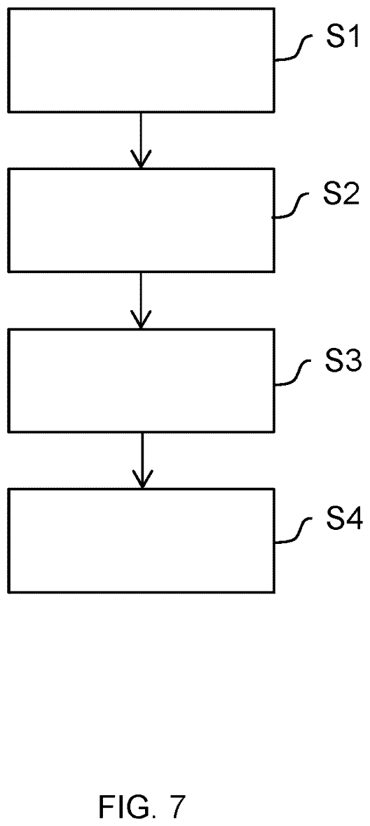

FIG. 7 shows a flow chart for a method for measuring the surroundings of a vehicle.

Identical or functionally identical elements have been provided with the same reference signs in the figures, unless stated otherwise.

FIG. 1 shows an exemplary vehicle, a motor vehicle 10 having multiple sensor arrangements 20, 21, which comprise ultrasonic transceivers. The multiple sensor arrangements 20, 21 are arranged in a front apron 60 and in a rear apron, both not directly visible in the top view of FIG. 1, of the motor vehicle 10. In the schematic illustration, the sensor arrangements 20, 21 are shown superimposed for better recognizability. In most motor vehicles 10, the sensor arrangements 20, 21 are embodied as surface-flush, so that they do not protrude or only protrude minimally out of the front apron or rear apron or are set back in relation thereto.

The ultrasonic transceivers of the sensor arrangements 20, 21 are embodied having a cup-shaped membrane, which terminates flatly with the outside of the vehicle and can be painted in the color of the motor vehicle 10. The flat plane of the membrane is fitted into the plane of the front apron 60 or rear apron. The sensor arrangements 20, 21 are often only recognizable by a silicone decoupling between the front apron or rear apron and the sensor arrangements 20, 21, which is visible as a circle.

A widening 30 of the transmitted ultrasonic waves is shown for the ultrasonic transceiver of the sensor arrangement 21. The ultrasonic transceiver of the sensor arrangement 21 emits the ultrasonic waves into the surroundings 40 of the motor vehicle 10. The ultrasonic transceiver of the sensor arrangement 21 emits its maximum power perpendicular to the surface of the membrane fitted in the plane of the front apron. In the horizontal plane, the emitted ultrasonic waves have an opening angle of a directional characteristic of approximately 120°. In the vertical plane, the opening angle is approximately 60°.

The emitted ultrasonic waves can be reflected at an obstacle 50. The distance of the obstacle 50 from the ultrasonic transceiver of the sensor arrangement 21 can be calculated from the combined time-of-flight of the emitted ultrasonic waves to the obstacle and the time-of-flight of the reflected ultrasonic waves back to the ultrasonic transceiver of the sensor arrangement 21. If ultrasonic transceivers of multiple sensor arrangements 20, 21 are used, the position of the obstacle 50 can be determined from the different times-of-flight by means of known methods of trilateration.

FIG. 2 schematically shows the sensor arrangement 21 and the reflection of ultrasonic waves at an obstacle 50. The ultrasonic waves can be emitted as a pulse or pulse sequence. The ultrasonic waves have a directional characteristic and propagate with an opening angle of approximately 120° in the horizontal plane of the motor vehicle 10. The propagation 30 of the transmitted ultrasonic waves is shown by solid arcs in FIG. 2. If the emitted ultrasonic waves strike an obstacle 50, a part of the emitted ultrasonic waves which strikes the obstacle 50 can be reflected. The propagation 70 of the reflected ultrasonic waves is shown by dashed arcs in FIG. 2. A part of the reflected ultrasonic waves strikes the ultrasonic transceiver of the sensor arrangement 21. The distance of the obstacle from the ultrasonic transceiver of the sensor arrangement 21 can be calculated from the time-of-flight of the pulses or pulse sequences from the ultrasonic transceiver of the sensor arrangement to the obstacle 50 and back.

FIG. 3 shows a sensor arrangement 21 and the reflection of ultrasonic waves at a nearby obstacle and the shading of a more distant object. If the obstacle 50 of FIG. 2 moves closer and closer to the ultrasonic transceiver of the sensor arrangement 21, the time-of-flight of the pulse or the pulse sequences from the ultrasonic transceiver of the sensor arrangement 21 to the obstacle and back becomes shorter and shorter. If the reflected ultrasonic waves reach the ultrasonic transceiver while these ultrasonic waves are still being emitted as pulses or pulse sequences or shortly after the emission, the ultrasonic transceiver is “blind” to the reflected ultrasonic waves. The obstacle 50 can then no longer be detected. If the obstacle 50 is laterally offset, shown by dashed lines in FIG. 3, it can possibly still be detected in spite of being at the same distance from the front apron 60 because of the longer time-of-flight. A distance from the ultrasonic transceiver of at least 10 cm is necessary in many ultrasonic transceivers for the detection of the obstacle 50, because the time-of-flight of the ultrasonic waves emitted in the form of pulses or pulse sequences is then long enough that the membrane is no longer excited and has finished oscillating, so that reflected ultrasonic waves can be received and reflections due to the obstacle 50 can be detected.

In the case of an obstacle 50 which is located nearby in front of the ultrasonic sensor of the sensor arrangement 21, there is additionally the hazard that even a significantly larger object 80 behind the obstacle 50 will be shaded. The obstacle 50 reflects or scatters the incident ultrasonic waves, so that they cannot reach the object 80 or can only still reach it in attenuated form.

FIG. 4 shows a sensor arrangement 21 and the reflection of ultrasonic waves (a corresponding ultrasonic transceiver of the sensor arrangement 21 is not shown in FIG. 4) at a nearby obstacle and the shading of a more distant object and the illumination of the obstacle with light. If light is emitted and reflected light is received by the sensor arrangement 21 having an optical transceiver device (not shown in FIG. 4), this can be used as additional information as to whether an obstacle is located in front of the sensor arrangement 21. In the exemplary embodiment of FIG. 4, the propagation of the light is shown on the basis of two light cones. Two infrared diodes emit light at a wavelength of 850 nm. If the emitted light strikes the obstacle 50, a part of the light is reflected. The reflected light can be received using two phototransistors. A threshold value is defined for the phototransistors using a comparator circuit. If the threshold value is exceeded, an obstacle can be detected. In this way, additional security can be created that an obstacle close to the ultrasonic transceiver of the sensor arrangement 21 will not be overlooked. The implementation of the optical transceiver device using infrared diodes and phototransistors is possible cost-effectively. The integration in conventional ultrasonic sensors with an ultrasonic transceiver but without optical transceiver device is often easily implementable, since existing electronics 140, e.g., ICs, ASICs, microprocessors, and memory can also be used. Often, for example, a so-called GPIO (General Purpose Input/Output) is provided on an IC of the ultrasonic sensor, which can be used for the signal processing of the optical transceiver device, for example, for connection to the phototransistor and for measurement of the voltage of the phototransistor generated by the received reflected light.

FIG. 5 schematically shows a section through a sensor arrangement 21 having an ultrasonic transceiver 100 and an optical transceiver device 101 in a front apron 60. The ultrasonic transceiver 100 and the optical transceiver device 101 are preferably integrated in a common housing 105. A membrane 110 of the ultrasonic transceiver 100 is arranged on or partially in the housing 105. The membrane 110 is cup-shaped, having a flat area which is introduced in the plane of the front apron 60, and a cylindrical area of greater material thickness, via which the membrane 110 is connected to the housing 105. The connection is established by a potting compound 120, alternatively the membrane 110 can also be connected to the housing 105, for example, by adhesive bonding, extrusion, or embedding. The membrane 110 is connected by the potting compound 120 to the housing 105 so that water cannot penetrate into the housing. The membrane is manufactured from metal, in particular from aluminum. A piezoelectric element 130 is located inside the membrane 110 and is protected thereby.

The membrane 110 and the piezoelectric element 130 are part of the ultrasonic transceiver 100. Electronics 140 of the ultrasonic transceiver 100 having a microprocessor having memory are used to generate pulses or pulse sequences having a carrier frequency using the piezoelectric element 130, which are emitted using the membrane 110. The electronics 140 of the ultrasonic transceiver 100 are also used to evaluate ultrasonic waves which strike the membrane 110, in particular in the form of reflected pulses or pulse sequences.

An infrared light-emitting diode 150 and a phototransistor 160 are also embedded in the potting compound 120. The infrared light-emitting diode 150 and the phototransistor 160 are part of the optical transceiver device 101. Electronics 170 of the optical transceiver device 101 having a microprocessor having memory are used to emit light signals using the infrared light-emitting diode 150 and receive and evaluate light signals using the phototransistor 160. The infrared light-emitting diode 150 and the phototransistor 160 are also firmly connected to the housing 105 via the potting compound 120. In the housing 105, the light-emitting diode 150 and the phototransistor 160 are connected to the electronics 170 of the optical transceiver device via wires or conductor tracks. Common electronics 140, 170 can also be used for the ultrasonic transceiver 100 and the optical transceiver device 101.

The housing 105 has a connection 180, for example, a plug connection, for the supply of the optical transceiver device 101 and the ultrasonic transceiver 100 with electrical energy and for the transport of data from and to the optical transceiver device 101 and the ultrasonic transceiver 100, for example, from a control unit of the motor vehicle 10. The housing 105 is arranged using a decoupling ring 190 on the front apron 60. The decoupling ring 190 is extruded onto the membrane 110 and the potting compound 120, alternatively, the decoupling ring 190 can also be plugged on, potted, or adhesively bonded. The decoupling ring 190 reduces the transfer of oscillations of the membrane 110 directly or via the housing 105 to the front apron 60.

Optical fibers 200 are introduced, for example, embedded, in the decoupling ring 190. Light of the infrared light-emitting diode 150 can reach the outside of the front apron 60 and can be emitted into the surroundings 40 of the motor vehicle 10 through the optical fibers and, vice versa, reflected light can reach the phototransistor 160 from the surroundings of the motor vehicle 10.

FIG. 6 schematically shows a top view from the surroundings 40 of the motor vehicle 10 of a sensor arrangement 21 having an ultrasonic transceiver and an optical transceiver device in a front apron 60. The decoupling ring 190 is transparent to the light of the infrared light-emitting diodes 150 here, so that the sensor arrangement 21 manages without waveguide 200, since the emitted and received light of the optical transceiver device can penetrate the decoupling ring 190. The outer circumference of the decoupling ring 190 is approximately 30 mm. The sensor arrangement 21 fits into the installation space which is also available for a conventional ultrasonic sensor, since the decoupling ring 190 surrounding the membrane 110 is used to emit light of the optical transceiver device and receive reflected light. Due to the compact configuration of the sensor arrangement 21, the optical transceiver device can in particular cover the close range in front of the ultrasonic transceiver well.

In FIG. 6, the sensor arrangement 21 for the optical transceiver device comprises two infrared light-emitting diodes 150 and two phototransistors 160. The detection range of the optical transceiver device can be determined by the use of two infrared light-emitting diodes 150 and two phototransistors 160 and the system can be embodied redundantly. Due to an arrangement of the infrared light-emitting diodes 150 in the horizontal plane, for example, a wider detection in the horizontal plane results, due to the arrangement in the vertical direction, the detection of obstacles in the close range upward and downward is better.

Soiling on an infrared light-emitting diode 150 or a phototransistor 160 and therefore absent reflections of the emitted light can be compensated for by the other pair of infrared light-emitting diode 150 and phototransistor 160.

If, in the evaluation of received light signals for a pair of infrared light-emitting diode 150 and phototransistor 160 lying close to one another, for example, the upper pair in FIG. 6, a strong reflection is established due to a strong received light signal and if no reflection is established for the second pair located close to one another, for example, the lower pair in FIG. 6, soiling in the area of the sensor arrangement 21, which shades the upper pair of infrared light-emitting diode 150 and phototransistor 160 of the sensor arrangement 21, can be concluded.

FIG. 7 shows a flow chart for a method for measuring the surroundings 40 of a vehicle 10, as can be carried out in particular using the described sensor device 20, 21.

In a step S1, ultrasonic signals are transmitted and received using an ultrasonic transceiver. The ultrasonic transceiver has a membrane 110 for this purpose, which can be excited using a piezoelectric element 130 and can generate ultrasonic waves. The piezoelectric element 130 and the membrane 110 can be excited using electronics 140 of the ultrasonic transceiver so that ultrasonic signals are transmitted. If the transmitted ultrasonic signals strike an obstacle 50, a part can be reflected. If the reflected ultrasonic signals strike the membrane 110 again, they can be received by the ultrasonic transceiver.

In a step S2, light signals are transmitted and received using an optical transceiver device. Step S2 can take place in parallel, alternately with, after, or before step S1. A light-emitting diode 150 is actuated using electronics 170 of the optical transceiver device and light signals are emitted using the light-emitting diode. If the emitted light signals strike an obstacle 50, a part can be reflected. If the reflected light signals strike a phototransistor 160 or a photodiode of the optical transceiver device, they can be received by the optical transceiver device.

In a step S3, the received ultrasonic signals are evaluated for obstacles 50 in the surroundings 40 of the vehicle 10. For this purpose, a search is made for peaks in the received ultrasonic signals, which correspond to reflections from obstacles 50. The distance of the obstacle 50 is calculated from the time-of-flight of the ultrasonic signals to the obstacle 50 and back to the ultrasonic transceiver. If multiple ultrasonic transceivers are used, the position of an obstacle can also be determined via trilateration. However, if the obstacle 50 is too close to the ultrasonic transceiver, the reflected ultrasonic signal reaches the membrane 110 while it is still excited for the transmission of ultrasonic waves or still continues to oscillate from the excitation and the ultrasonic signal cannot be received. An obstacle is then not detected.

In a step S4, the received light signals are evaluated for obstacles 50 in the surroundings 40 of the vehicle 10. Step S4 can take place in parallel, alternately with, after, or before step S3. A brightness value for the received light signal is compared with a threshold value in this case. If the brightness value is above the threshold value, an obstacle is detected. Light signals having wavelengths which naturally occur as little as possible or not at all in the surroundings 40 of the vehicle 10, for example, in the near infrared, are used for the evaluation. The threshold value is selected so that only obstacles 50 are detected which are not detected by the ultrasonic transceiver, because they are located too close to the ultrasonic transceiver. For example, the threshold value can be experimentally defined so that obstacles 50 which are frequent or are especially to be taken into consideration, such as pedestrians, are detected as much as possible. A starting release is only granted by the electronics 170 for the optical transceiver device when no obstacle is detected. Only when a starting release of the electronics for the optical transceiver device and a starting release of the electronics 140 of the ultrasonic transceiver are present will a starting release be granted for an automated driving maneuver and an automated parking entry or departure process can start, for example.

### LIST OF REFERENCE SIGNS

10 motor vehicle
20, 21 sensor arrangement
30 propagation of the ultrasonic waves
40 surroundings of the motor vehicle
50 obstacle
60 front apron
70 propagation of the reflected ultrasonic waves
80 object
90 light cone
100 ultrasonic transceiver
101 optical transceiver device
105 housing
110 membrane
120 potting compound
130 piezoelectric element
140 electronics of the ultrasonic transceiver
150 infrared light-emitting diode
160 phototransistor
170 electronics of the optical transceiver device
180 connection
190 decoupling ring
200 optical fiber
S1 transmitting and receiving ultrasonic signals
S2 transmitting and receiving light signals
S3 evaluating received ultrasonic signals
S4 evaluating received light signals

1. A sensor arrangement for a vehicle, comprising:
an ultrasonic transceiver configured to emit ultrasonic waves and receive reflected ultrasonic waves; and
an optical transceiver device configured to emit light and receive reflected light.

2. The sensor arrangement as claimed in claim 1, wherein the ultrasonic transceiver and the optical transceiver device are arranged in a housing.

3. The sensor arrangement as claimed in claim 1, or wherein the optical transceiver device comprises a light-emitting diode or a laser.

4. The sensor arrangement as claimed in claim 1, wherein the optical transceiver device comprises a photodiode or a phototransistor.

5. The sensor arrangement as claimed in claim 1, wherein the optical transceiver device comprises two infrared light-emitting diodes and two phototransistors or photodiodes.

6. The sensor arrangement as claimed in claim 1, comprising a decoupling ring for decoupling oscillations of the ultrasonic transceiver of the sensor arrangement from a device accommodating the sensor arrangement.

7. The sensor arrangement as claimed in claim 6, wherein the decoupling ring is configured to conduct the transmitted and/or reflected light through to the optical transceiver device.

8. The sensor arrangement as claimed in claim 6, wherein the decoupling ring is transparent to the emitted and/or reflected light.

9. The sensor arrangement as claimed in claim 7, or wherein the decoupling ring comprises an optical fiber for conducting the emitted and/or reflected light.

10. A bumper, a front apron, or a rear apron comprising one or more of the sensor arrangements as claimed in claim 1.

11. A vehicle comprising: one or more of the sensor arrangements as claimed in claim 1 and/or a bumper, a front apron, or a rear apron.

12. A method for measuring surroundings of a vehicle, using a sensor arrangement as claimed in claim 1, comprising:
transmitting and receiving ultrasonic signals;
transmitting and receiving light signals;
evaluating the received ultrasonic signals for obstacles in the surroundings of the vehicle; and
evaluating the received light signals for obstacles in the surroundings of the vehicle.

13. The method as claimed in claim 12, wherein the received ultrasonic signals are evaluated for obstacles at a distance of at least 5 cm from a transmitting ultrasonic transceiver and/or the received light signals are evaluated for obstacles at a distance of less than 20 cm from a transmitting optical transceiver device.

14. The method as claimed in claim 12, wherein a starting release is only granted when no obstacle, within an intended travel distance, results for an intended travel direction from the evaluated ultrasonic signals and from the evaluated light signals.

15. A non-transitory computer readable medium comprising a computer program product, comprising commands which, upon execution of the program by a computer, prompt it to carry out the method as claimed in claim 12.
